(19) United States
(12) Patent Application Publication
(10) Pub. No.: US 2005/0169564 A1
(43) Pub. Date: Aug. 4, 2005

(54) Rotating assembly with a bearing pressed by a resilient ring

(75) Inventor: Yan-Jun Jia, Chang-An Town Dong-Guan City (CN)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Asia Optical Co., Inc., Taichung (TW)

(21) Appl. No.: 10/866,379

(22) Filed: Jun. 10, 2004

(30) Foreign Application Priority Data
Jan. 30, 2004 (TW) 093102178

(51) Int. Cl. F16C 33/66; F16C 19/00; F16C 33/40

(52) U.S. Cl. 384/517

(57) ABSTRACT

A rotating assembly includes an annular housing having a flange extending radially and inwardly therefrom, a rotating shaft disposed within the housing, an annular locking member sleeved fixedly on the rotating shaft, and a bearing disposed between the housing and the rotating shaft along a radial direction of the rotating shaft and between the locking member and the flange along an axial direction of the rotating shaft. The bearing includes an outer race connected to the housing, and an inner race connected to the rotating shaft and rotatable relative to the outer race. A resilient ring is clamped between one of the inner and outer races and one of the flange of the housing and the locking member so as to permit the inner and outer races of the bearing to deflect from each other along the radial direction of the rotating shaft.

### CROSS-REFERENCE TO RELATED APPLICATION

This application claims priority of Taiwanese Application No. 093102178, filed on Jan. 30, 2004.

### BACKGROUND OF THE INVENTION

1. Field of the Invention

This invention relates to a rotating assembly, such as a motor, and more particularly to a rotating assembly that is provided with a bearing that is pressed by a resilient ring.

2. Description of the Related Art

Referring to FIG. 1, a conventional rotating assembly in the form of a DC brushless motor is shown to include an annular housing 1, a rotating shaft 2 disposed within the housing 1, a coil unit 3 wound around an outer peripheral surface of the housing 1, a loading member 4 connected fixedly to one end of the rotating shaft 2, a rotating sleeve 5 connected fixedly to the loading member 4 and disposed rotatably around the coil unit 3, a ring magnet 6 connected fixedly to an inner surface of the rotating sleeve 5 and disposed rotatably around the coil unit 3, a locking member 7 sleeved fixedly on the other end of the rotating shaft 2, two bearings 8 disposed between the housing 1 and the rotating shaft 2, and a coiled compression spring 9. The housing 1 is formed with a flange 101 extending radially and inwardly from an inner peripheral surface thereof and having an L-shaped cross-section to define an annular groove 102 between the flange 101 and the inner peripheral surface of the housing 1. Each of the bearings 8 is configured as a ball bearing, and includes an outer race 801 connected to the housing 1, an inner race 802 connected to the rotating shaft 2, and a plurality of balls 803 disposed between the inner and outer races 802, 801. The spring 9 is disposed between the flange 101 of the housing 1 and the outer race 801 of the upper bearing 8.

The spring 9 presses against the outer race 801 of the upper bearing 8 along an axial direction of the rotating shaft 2 so as to deflect the inner and outer races 802, 801 of the upper bearing 8 from each other along a radial direction of the rotating shaft 2. As such, spaces between the balls 803 and the inner and outer races 802, 801 can be eliminated so as to permit the balls 803 to be kept clamped between the inner and outer races 802, 801, thereby prolonging the service life of the upper bearing 8. Although the spring 9 can achieve its intended purposes, in actual use, it suffers from the following disadvantages:

(1) Because the total length and diameter of the spring 9 are relatively large, the motor is too bulky to be mounted within a comparatively small space.

(2) Rotation of the rotating shaft 2 within the housing 1 results in vibration of the spring 9, which will produce relatively loud noise.

### SUMMARY OF THE INVENTION

The object of this invention is to provide a compact rotating assembly that includes a bearing pressed by a resilient ring so as to reduce the vibration and noise of the rotating assembly during use.

According to this invention, a rotating assembly includes an annular housing having a flange extending radially and inwardly therefrom, a rotating shaft disposed within the housing, an annular locking member sleeved fixedly on the rotating shaft, and a bearing disposed between the housing and the rotating shaft along a radial direction of the rotating shaft and between the locking member and the flange along an axial direction of the rotating shaft. The bearing includes an outer race connected to the housing, and an inner race connected to the rotating shaft and rotatable relative to the outer race. A resilient ring is clamped between one of the inner and outer races of the bearing and one of the flange of the housing and the locking member so as to press against the one of the inner and outer races of the bearing along the axial direction of the rotating shaft, thereby permitting the inner and outer races of the bearing to deflect from each other along the radial direction of the rotating shaft.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a longitudinal sectional view of a conventional DC brushless motor;

FIG. 2 is an exploded perspective view of the first preferred embodiment of a rotating assembly according to this invention;

FIG. 3 is a longitudinal sectional view of the first preferred embodiment;

FIG. 4 is an exploded perspective view of the second preferred embodiment of a rotating assembly according to this invention;

FIG. 5 is a longitudinal sectional view of the second preferred embodiment; and

FIG. 6 is a fragmentary longitudinal sectional view of the second preferred embodiment, illustrating how a resilient ring is connected to a locking member.

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

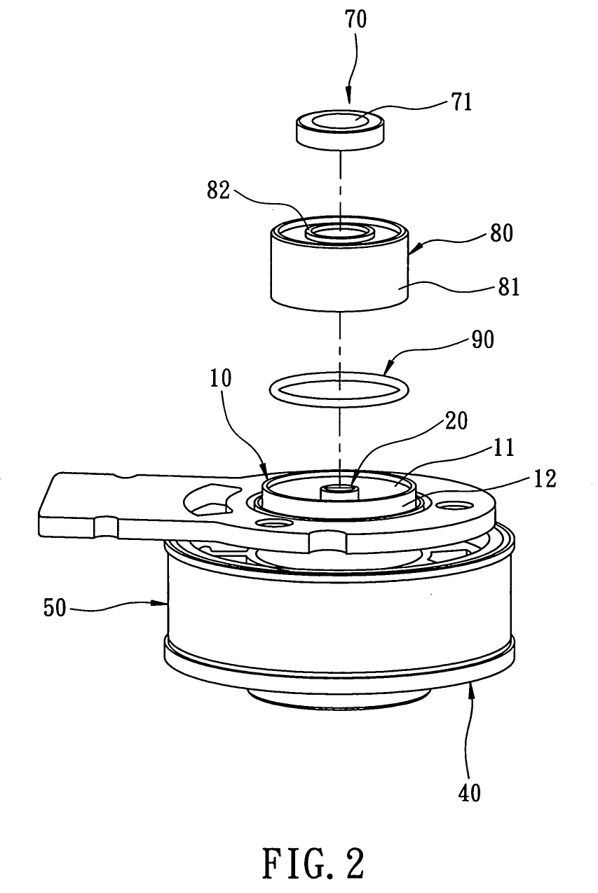

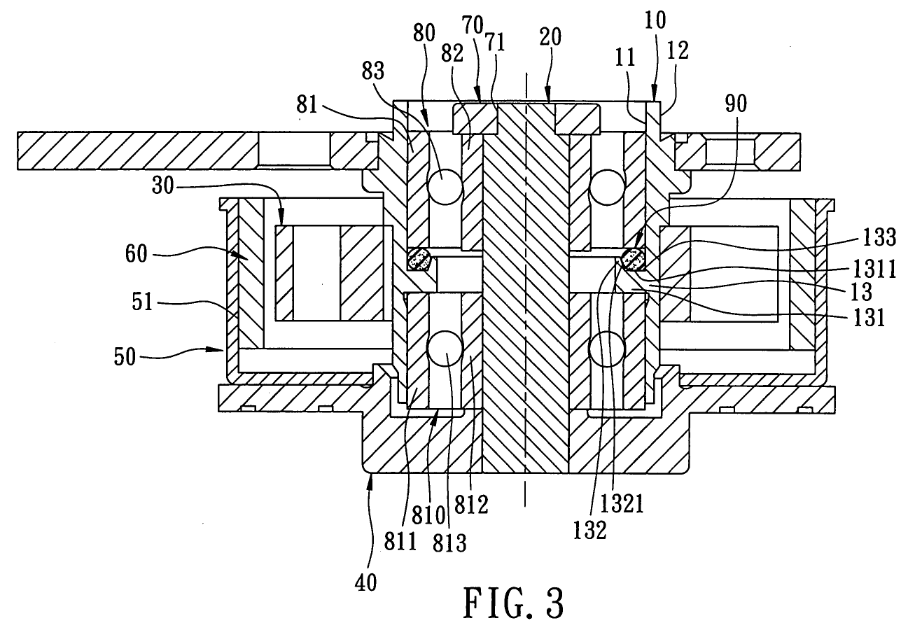

Referring to FIGS. 2 and 3, the first preferred embodiment of a rotating assembly according to this invention is configured as a DC brushless motor, and is shown to include an annular housing 10, a rotating shaft 20, a coil unit 30, a loading member 40, a rotating sleeve 50, an annular magnetic member 60, an annular locking member 70, two bearings 80, 810, and a resilient ring 90.

The housing 10 has an inner peripheral surface 11, an outer peripheral surface 12, and a flange 13 extending radially and inwardly from the inner peripheral surface 11. The flange 13 has a generally L-shaped cross-section, an annular radial flange portion 131 extending radially and inwardly from the inner peripheral surface 11, and an annular axial flange portion 132 extending from an inner periphery of the radial flange portion 131 toward the upper bearing 80. As such, an annular groove 133 is defined among the inner peripheral surface 11 of the housing 10, a planar ring-engaging surface 1311 of the radial flange portion 131, and a planar ring-engaging surface 1321 of the axial flange portion 132. The ring-engaging surfaces 1311, 1321 of the radial flange portion 131 and the axial flange portion 132 form an obtuse angle therebetween.

The rotating shaft 20 is disposed within the housing 10.

The coil unit 30 is configured as a stator coil, and is wound around the outer peripheral surface 12 of the housing 10.

The loading member 40 is sleeved fixedly on a lower end of the rotating shaft 20.

The rotating sleeve 50 is disposed rotatably around the housing 10, and is connected fixedly to the loading member 40.

The magnetic member 60 is configured as a ring magnet, is connected fixedly to an inner surface 51 of the rotating sleeve 50, and is disposed rotatably around the coil unit 30.

The locking member 70 has a central bore 71, and is sleeved fixedly on an upper end of the rotating shaft 20.

The bearings 80, 810 are disposed between the housing 10 and the rotating shaft 20 along a radial direction of the rotating shaft 20. The bearing 80 is disposed between the locking member 70 and the flange 13 of the housing 10 along an axial direction of the rotating shaft 20. Each of the bearings 80, 810 includes an outer race 81, 811 connected to the housing 10 in a known manner, and an inner race 82, 812 connected to the rotating shaft 20 in a known manner and rotatable relative to the outer race 81, 811. The inner race 82 of the bearing 80 abuts against the locking member 70.

The resilient ring 90 is configured as an O-ring, is made of silicon rubber, and is clamped between the flange 13 of the housing 10 and the outer race 81 of the bearing 80 so as to press against the outer race 81 of the bearing 80 along the axial direction of the rotating shaft 20. As such, the inner and outer races 82, 81 of the bearing 80 are deflected from each other along the radial direction of the rotating shaft 20 so as to prolong the service life of the motor. The resilient ring 90 has an outer side portion that presses against the outer race 82 of the bearing 80, and an inner side portion that is opposite to the outer side portion, that is disposed within the annular groove 133, and that abuts against the ring-engaging surfaces 1311, 1321 of the radial flange portion 131 and the axial flange portion 132 of the flange 13 of the housing 10.

Some of the advantages of this invention can be summarized as follows:

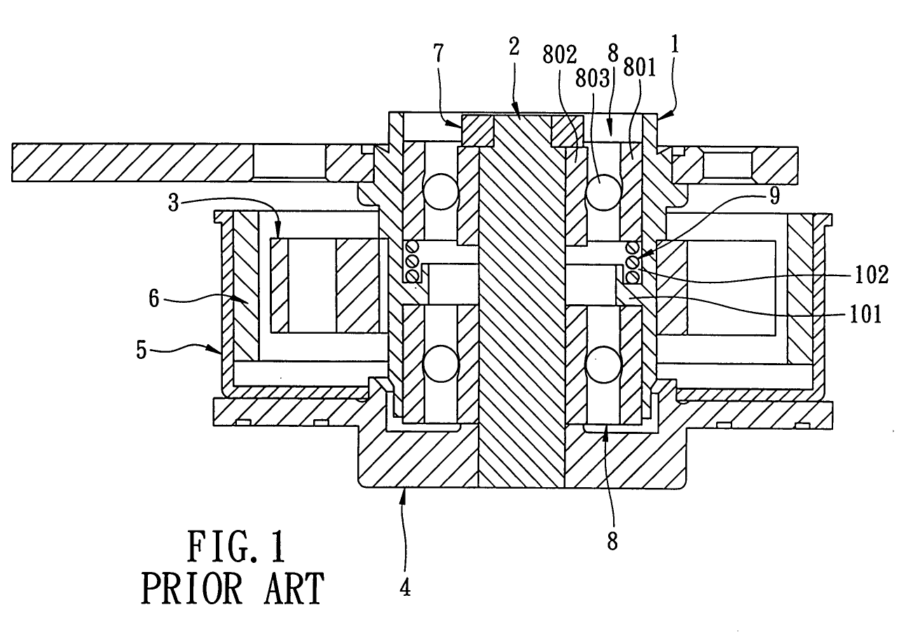

(1) Because the resilient ring 90 has a circular cross-section of a relatively small diameter, an increase in the total axial length of the motor resulting from the resilient ring 90 is much smaller than that of the prior art shown in FIG. 1 which employs the spring 9 (see FIG. 1), thereby resulting in a considerable increase in the applicable range of the motor.

(2) When the rotating shaft 20 rotates within the housing 10, the resilient ring 90 deforms so as to be kept in contact with the housing 10 and the upper race 81 of the bearing 80, thereby preventing noise resulting from collision of the resilient ring 90 against the housing 10 and the upper race 81 of the bearing 80 during use.

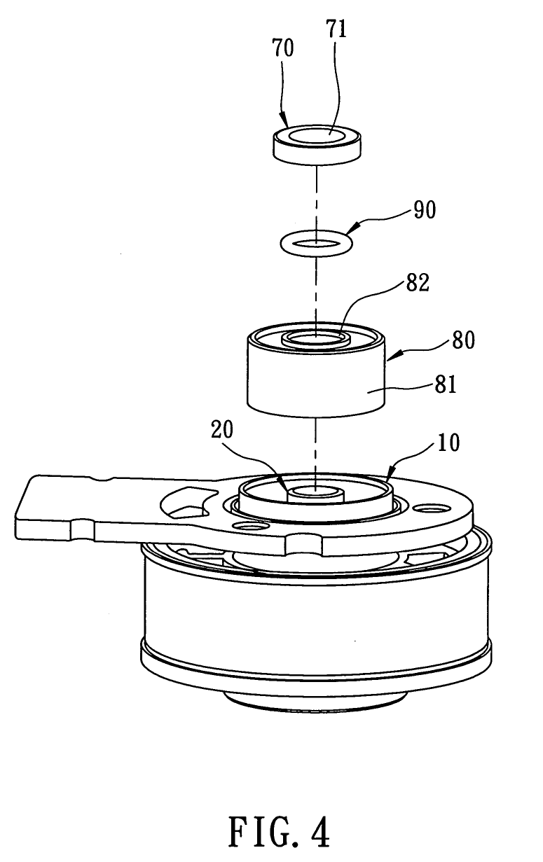

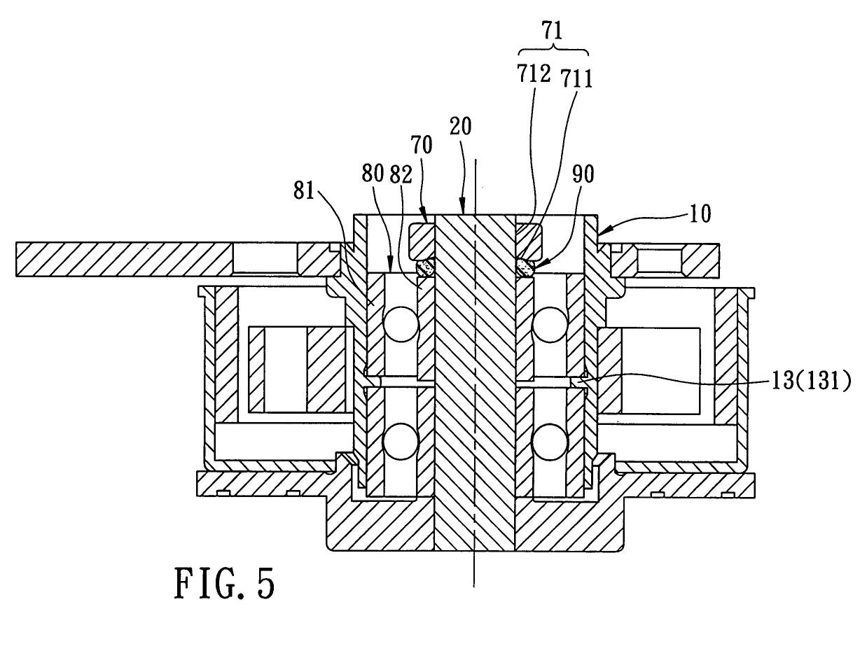

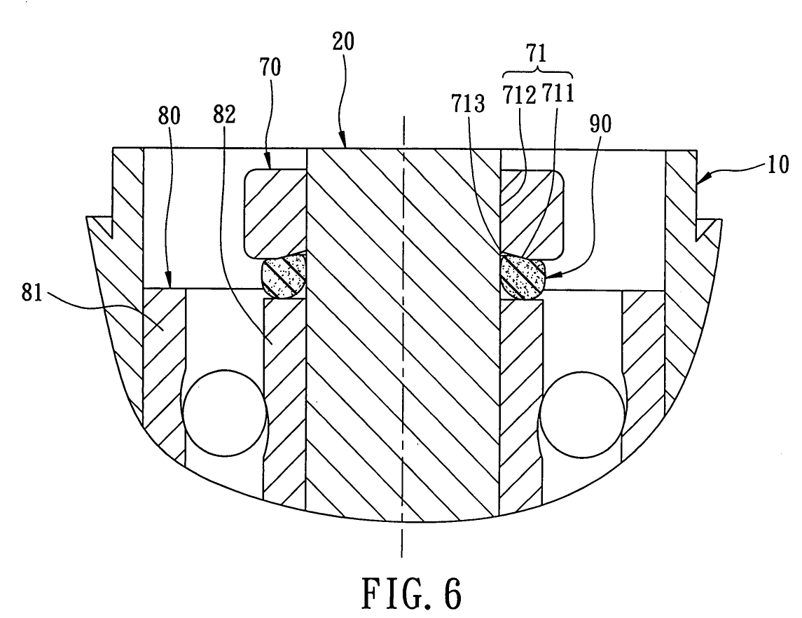

FIGS. 4, 5, and 6 show the second preferred embodiment of a rotating assembly according to this invention. Unlike the previous embodiment, the resilient ring 90 is clamped between the inner race 82 of the bearing 80 and the locking member 70. The outer race 81 of the bearing 80 abuts against the flange 13 of the housing 10. The flange 13 of the housing 10 has only the radial flange portion 131. That is to say, no axial flange portion 132 (see FIG. 3) is formed on the radial flange portion 131. The locking member 70 is formed with a central bore 71. The rotating shaft 20 extends through the central bore 71 in the locking member 70. The central bore 71 in the locking member 70 has a diverging bore end 711 and a uniform-diameter bore portion 712. The locking member 70 is sleeved fixedly on the rotating shaft 20 in a tight fitting manner at the uniform-diameter bore portion 712 of the central bore 71 in the locking member 70. The locking member 70 and the rotating shaft 20 define cooperatively a ring-accommodating space 713 therebetween at the diverging bore end 711 of the central bore 71 in the locking member 70. The resilient ring 90 has an outer side portion that is received within the ring-accommodating space 713. As such, the inner and outer races 82, 81 of the bearing 80 can also be deflected from each other.

With this invention thus explained, it is apparent that numerous modifications and variations can be made without departing from the scope and spirit of this invention. It is therefore intended that this invention be limited only as indicated by the appended claims.

1. A rotating assembly comprising:
an annular housing having an annular inner peripheral surface and a flange extending radially and inwardly from said inner peripheral surface;
a rotating shaft disposed within said housing;
an annular locking member sleeved fixedly on said rotating shaft;
a bearing disposed between said housing and said rotating shaft along a radial direction of said rotating shaft and between said locking member and said flange along an axial direction of said rotating shaft, said bearing including an outer race connected to said housing, and an inner race connected to said rotating shaft and rotatable relative to said outer race; and
a resilient ring clamped between one of said inner and outer races of said bearing and one of said flange of said housing and said locking member so as to press against said one of said inner and outer races of said bearing along the axial direction of said rotating shaft, thereby permitting said inner and outer races of said bearing to deflect from each other along the radial direction of said rotating shaft.

2. The rotating assembly as claimed in claim 1, wherein said resilient ring is clamped between said flange of said housing and said outer race of said bearing, said locking member abutting against said inner race of said bearing.

3. The rotating assembly as claimed in claim 2, wherein said flange of said housing has a generally L-shaped cross-section, an annular radial flange portion extending radially and inwardly from said inner peripheral surface of said housing, and an annular axial flange portion extending from an inner periphery of said radial flange portion toward said bearing along the axial direction of said rotating shaft so as to define an annular groove among said inner peripheral surface of said housing, said radial flange portion of said flange of said housing, and said axial flange portion of said flange of said housing, said resilient ring having an outer side portion that presses against said outer race of said bearing, and an inner side portion that is opposite to said outer side portion and that is disposed within said annular groove.

4. The rotating assembly as claimed in claim 3, wherein each of said radial flange portion and said axial flange portion of said flange of said housing has a planar ring-engaging surface that abuts against said resilient ring, said ring-engaging surfaces of said radial flange portion and said axial flange portion of said flange of said housing forming an obtuse angle therebetween.

5. The rotating assembly as claimed in claim 1, wherein said resilient ring is clamped between said inner race of said bearing and said locking member, said outer race of said bearing abutting against said flange of said housing.

6. The rotating assembly as claimed in claim 5, wherein said locking member is formed with a central bore, said rotating shaft extends through said central bore in said locking member, said central bore in said locking member having a diverging bore end and a uniform-diameter bore portion, said locking member being sleeved fixedly on said rotating shaft in a tight fitting manner at said uniform-diameter bore portion of said central bore in said locking member, said locking member and said rotating shaft defining cooperatively a ring-accommodating space therebetween at said diverging bore end of said central bore in said locking member, said resilient ring having an outer side portion that is received within said ring-accommodating space.

7. The rotating assembly as claimed in claim 1, wherein said resilient ring is configured as an O-ring, and is made of silicon rubber.

8. The rotating assembly as claimed in claim 1, where said locking member is sleeved fixedly on one end of said rotating shaft, said rotating assembly further comprising:
a coil unit wound around said housing;
a loading member connected fixedly to the other end of said rotating shaft;
a rotating sleeve disposed rotatably around said housing and connected fixedly to said loading member; and
an annular magnetic member connected fixedly to an inner surface of said rotating sleeve and disposed rotatably around said coil unit.
